(19) United States
(12) Patent Application Publication
(10) Pub. No.: US 2008/0201251 A1
(43) Pub. Date: Aug. 21, 2008

(54) WEBSITE EXCHANGE BASED ON TRADERS BUYING AND SELLING FICTITIOUS SHARES OF WEBSITES BASED UPON ANTICIPATED RETURNS OF WEBSITES

(76) Inventors: Malik Magdon-Ismail, Loudonville, NY (US); Parag Patel, Marina Del Rey, CA (US)

Correspondence Address: STETINA BRUNDA GARRED & BRUCKER, 75 ENTERPRISE, SUITE 250, ALISO VIEJO, CA, 92656, US

(21) Appl. No.: 11/677,172

(22) Filed: Feb. 21, 2007

(51) Int. Cl. G06Q 40/00

(52) U.S. Cl. 705/37

(57) ABSTRACT

A method for generating data related to a plurality of websites by facilitating the exchange of fictitious shares of the plurality of websites, the method comprising the steps of: correlating a predetermined number of fictitious shares to each website; setting a market price for the fictitious shares of each website; generating an electronic currency; receiving requests to execute orders related to the fictitious shares of the websites in connection with the electronic currency; adjusting the market price of the fictitious shares of the respective websites to reflect a current market price based on the requests to execute orders; generating market data related to the market price of the fictitious shares of the respective websites and ranking the plurality of websites based on the market data. There is also provided a system for generating website-related data in connection with an exchange of fictitious shares of a plurality of websites.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to a system and method of generating website-related data. More specifically, the present invention pertains to a system and method for the creation of a website exchange and the online trade of fictitious shares of a plurality of websites to generate website-related data that provides an indication of the value of a website. The website-related data may be provided to advertisers or market analysts as a website evaluation tool.

Internet is a vast collection of information, and some estimates place the size of the Internet as including more than eighty million websites. It is further estimated that 694 million people that are age 15 or over access the Internet from worldwide locations. Thus, the Internet has the potential to be a powerful marketing tool for a business of any size that is trying to establish a marketing presence. Moreover, businesses should strive to include the Internet in their marketing strategy because a transformation has occurred in the manner in which potential purchasers of goods and services seek information. Although many potential purchasers still visit the traditional brick and mortar stores and seek advice from other individuals who may have more knowledge about a particular product or service, an ever-increasing number of these individuals are turning to the Internet to gather product or service related data. In fact, some potential purchasers of goods and services use the various search engines as a principle portal of knowledge. Accordingly, websites that provide Internet searching capability services have become the leading destinations for a vast number of Internet users. As such, advertisers must recognize that the Internet is where potential customers are headed, and if the advertiser wants to stay visible and viable, online advertising should be addressed in almost every marketing strategy.

The Internet is often viewed as a communication and distribution channel that offers global accessibility to the many products and services offered by businesses around the world. Before the Internet and e-commerce, the ability to advertise internationally was a very time-consuming and expensive undertaking by any business. A local business can now quickly become a global vendor and expand its potential target market to include an almost unlimited number of people. The uploading of files to a website is practically all that is needed to create a worldwide presence. Although establishing an Internet presence does not guarantee sales, either nationally or internationally, the Internet provides many new ways to generate leads and potential customers over prior advertising methods.

The most efficient way for a business to utilize its advertising budget is to direct spending toward those who are most likely to be interested in the goods or services that the business can provide to potential purchasers. Unfortunately, the efforts to target only those individuals that have the highest probability of buying have not always been so easy, especially with traditional methods of advertising. For instance, large sums of money are spent on television advertisements that are broadcast to the population during commercial breaks of programming. Demographic studies are continuously conducted to determine the likes, dislikes, and other lifestyle behaviors of the television viewing audience of a particular channel or program. Businesses use this information to advertise during particular time slots of programs, such as during the commercial breaks, to reach a specific target audience that is most likely to be interested in their products based on these demographic studies. However, there is no guarantee that the particular viewing audience will have any interest in the goods or services that are being advertised by the business. Further, digital video recorders and other similar types of technology enable television viewers to skip over or avoid most, if not all, of the advertising on television. A target audience may not even be aware of the business or the goods and services it offers. In contrast, the Internet has an unrivaled ability to identify and track potential purchasers which can greatly improve the ability of an advertiser to target those individuals who exhibit the highest potential for purchasing products.

Advertisers are presented with many online methods of generating leads or potential purchasers for their goods or services, which may involve placing advertisements on their own websites or on the websites of others. For example, there are lead generating websites that claim an ability to generate leads that specifically pertain to the industry of the advertiser. These websites often provide promotional opportunities through marketing with sweepstakes, contests and loyalty programs. Ultimately, many of the leads generated by such websites are often found to be ineffective. For example, sweepstakes leads are rarely effective in providing a target or an actual purchaser. Sweepstakes generate leads that are usually Internet users who are interested in a free giveaway. Similarly, a contest that does not necessarily rise to the level of a sweepstakes is also an ineffective form of a lead generator because the leads are typically contest participants that want to win a free prize. Thus, the leads generated from such contest offerings will rarely, if ever, purchase anything that is marketed to them at a cost. Consequently, sweepstakes or contests, whether originating from the website of the advertiser or by placing the sweepstakes or contest offer on the website of a third party, may generate a high volume of leads which may only result in several individuals that actually make a purchase.

The most effective way for an advertiser to generate leads is to place advertisements on a successful website that has a lot of traffic that can be correlated to a target demographic of the advertiser. In the real world, the success of many businesses is generally measured by the stock market. The stock market is comprised of a number of real-time exchanges that allow individuals to buy and sell ownership interests in publicly-traded corporations. A stock exchange is an entity that is in the business of bringing together buyers and sellers of such publicly-traded stock. The stock market is an incredible indicator of the general and financial stability of a corporation and it also encourages investment and provides capital for new businesses and income for investors. The increasing popularity of the Internet provides a similar corporate-like environment where the success of a website may influence the online success of goods and services associated with the website.

It is not always easy to determine whether the website on which an advertiser places its advertisements will provide the amount of leads necessary to justify the cost of the advertisement. A website on which an advertiser places an advertisement may not receive a high amount of traffic, which means that less people are likely to view the advertisement. Moreover, the demographics of the visitors to the website may not match the targeted demographic of the advertiser, and the intended targets are less likely to view the advertisement. Thus, it is worthwhile to know in advance whether a website generates, or has the potential to generate, a lot of traffic and also whether the demographics of the visitors to the website match the demographics of the potential purchaser that the advertiser wants to target.

Several entities exist that are in the business of monitoring traffic data for websites. One such company is Alexa, which is a subsidiary of Amazon, Inc. located in San Francisco, Calif. Alexa is best known for its methods of gathering and providing traffic data for websites viewed by Internet users. Alexa requires that its users voluntarily download a toolbar to their computer system, which can be utilized in various browsers such as Internet Explorer, Mozilla and Netscape. The downloaded toolbar is active during each browsing session for a particular user, if the user so chooses to make the toolbar active. Alexa compiles the data gathered from the toolbar of each user and designates a rank for each of the websites visited by the users based solely on the traffic data collected for the vast number of websites that are visited by its users. In theory, Alexa, in connection with its toolbar, should provide the typical Internet behavior of a fair statistical sample of the Internet user population. In reality, Alexa is easily manipulated because some webmasters require their visitors to install the Alexa toolbar in order to utilize the services of a particular website. In addition, some webmasters have significantly improved their Alexa ranking by making the users designate their website as the user's homepage in order to access certain portions of the website. Further, many Alexa users are webmasters and marketing people whose own heavy use can cause the rank of a website to increase.

The fascination with the Internet and the associated trends in traffic data in connection with tools such as Alexa have spawned fictitious trading games related to Alexa. For example, the AlexaDex simulates a stock market exchange and is based solely on traffic data gathered from Alexa. The AlexaDex involves the trading of shares that correspond to the websites that are being tracked through the downloaded Alexa toolbar. The price of the shares is based solely on the Alexa reach. Specifically, the price is generally determined once a day and directly correlates to the rank of the website as determined by the traffic data, which is the number of hits or visits received by the website, as collected through the downloaded Alexa toolbar. The users of the AlexaDex buy and sell shares of stock of the websites according to a user prediction of the statistical traffic data for the next day, as opposed to supply and demand for the existing shares of the website. The AlexaDex is based on the traffic data obtained from Alexa which is generally not accurate website traffic data, nor is it an accurate depiction of the demographics of the Alexa toolbar users. Moreover, the current market prices are determined solely according to traffic data and therefore, the current market price has no correlation to future expectations for the website in terms of value.

What is lacking in the art is a system and method by which website-related data is generated that can be utilized in advertising and marketing to provide an accurate depiction of the demographics of website visitors and indication of the likelihood of success of Internet advertising on a website.

### BRIEF SUMMARY

A method for generating data related to a plurality of websites by facilitating the exchange of fictitious shares of the plurality of websites, the method comprising the steps of: correlating a predetermined number of fictitious shares to each website; setting a market price for the fictitious shares of each website; generating an electronic currency; receiving requests to execute orders related to the fictitious shares of the websites in connection with the electronic currency; adjusting the market price of the fictitious shares of the respective websites to reflect a current market price based on the requests to execute orders; generating market data based on the market price of the fictitious shares of the respective websites and ranking the plurality of websites based on the market data.

Market data generated from the method may be useful to advertisers and other analysts because it provides a market prediction of the future success of a website as it relates to the market price of the shares and website rank. In addition, the market data may assist website owners to optimize advertisements and websites and further enhance the businesses that may be associated with the websites.

Any number of fictitious shares may be correlated to a website. Alternatively, the number of fictitious shares may depend on external factors, which may include traffic data, website revenue, website-related events, revenue of the entity or individual that owns the website and business-related events. A predetermined number of fictitious shares of stock may also be correlated to a subsidiary webpage for one of a given number of websites. Similarly, the initial market price for the fictitious shares may be arbitrarily set or the initial market price may depend on external factors. According to one aspect of the invention, the method may further comprise a step of obtaining traffic data for at least one of a given number of websites. Accordingly, the step of ranking the plurality of websites may be based on the current market price and the traffic data for the websites.

According to another aspect of the invention, the method may further comprise a step of requiring a user to register for a trader account, wherein the receiving step includes receiving a request to execute an order from the user via the trader account. The trader account may be modified in response to a request to execute an order received from a user. The user may provide demographic data that is stored in association with the trader account. The demographic data may be provided to a third party in addition to the market data

According to another aspect of the invention, the method may further comprise a step of storing market data for the shares of the websites. The market data includes at least one of an initial market price per fictitious share, a current market price per fictitious share, a previous market price per fictitious share, a current website rank and a previous website rank. The method may further comprise a step of deriving market data that may be predictive for at least one of a given number of websites, wherein the predictive market data is derived from at least the market data for the websites. The predictive market data may include a future website rank, future traffic data and future market price per fictitious share. The market data may be provided to a third party such as an advertiser or other analyst.

A system for generating website-related data in connection with an exchange of fictitious shares of a plurality of websites, the system comprising: a host server configured to receive and transmit data related to the fictitious shares of the plurality of websites over a global communications network, the host server including: a client interface configured to direct communications received over the global communications network between the host server and a client device; a transaction engine configured to respond to orders associated with the exchange of the fictitious shares of the plurality of websites, the orders being received by the host server from the client device via the client interface; a pricing engine configured to receive data from the transaction engine related to the orders, the data related to the orders being used to calculate a current market price of the shares for at least a given one of the plurality of websites; and a research engine configured to respond to a request for data related to the orders and a database configured to store the data related to the orders.

### BRIEF DESCRIPTION OF THE DRAWINGS

These and other features and advantages of the various embodiments disclosed herein will be better understood with respect to the following description and drawings, in which like numbers refer to like parts throughout, and in which:

An illustrative and presently preferred embodiment of the present invention is shown in the accompanying drawings in which:

FIG. 1 is a schematic diagram illustrating the interaction between a host, a trader, an advertiser and several third data providers in generating and providing website-related data.

FIG. 2 is a schematic diagram of an exemplary system for generating and providing website-related data according to one aspect of the present invention.

FIG. 3 is a flowchart of a method of generating website-related data from the perspective of the host.

FIG. 4 is a flowchart of a method of trading fictitious shares of stock from the perspective of the trader.

FIG. 5 is an exemplary embodiment of a client interface that simulates a trader terminal.

FIG. 6 is a flowchart of a method of requesting and receiving website-related data from the perspective of the advertiser.

FIG. 7 is an exemplary embodiment of an advertiser interface according to one aspect of the present invention through which an advertiser may request and receive website-related data.

FIG. 8 is a method of providing website-related data to an advertiser from the perspective of the host.

### DETAILED DESCRIPTION

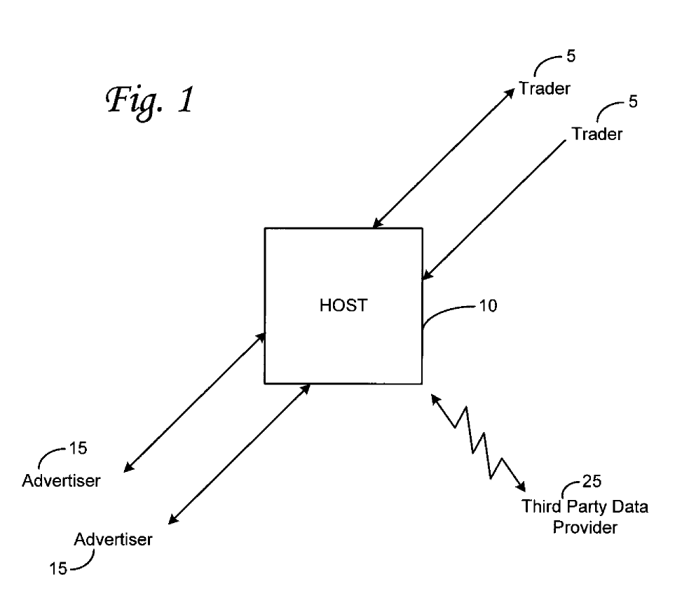

The drawings referred to herein are for the purposes of illustrating the embodiments of the present invention and not for the purpose of limiting herein. Referring to FIG. 1, there is shown a general schematic view of an exemplary system which illustrates the interaction between a host 10, a trader 5, an advertiser 15 and other third party data providers 25 in generating website-related data in connection with a website exchange. The system is directed to a website exchange created for an online trade of fictitious shares of stock of a plurality of websites to generate website-related data that may be useful to an advertiser for the purposes of advertising and marketing. The website-related data may assist advertisers and other market analysts in assessing trends and determining which types of websites are popular within particular definable segments of the population. For example, the website-related data may be utilized to make a determination regarding the placement of an advertisement on a particular website. The advertiser may want to target a specific demographic and the traders that hold the shares of stock for the website may meet that demographic. Although the interest of some of these traders may be purely financial, as it relates to the website exchange, it is likely that many of these traders frequently visit the website. Advertiser, as used herein, is an example of a third party that may be interested in the website-related data, as generated and provided by the system with regard to the online trade of the fictitious shares of stock. Other entities or individuals may also be interested in the website-related data for purposes that may or may not be related to advertising and marketing, including without limitation, academic research; the evaluation of internet trends as such trends may relate to a variety of topics or issues including without limitation social and political issues; or the valuation of a website or a business entity associated with the website,

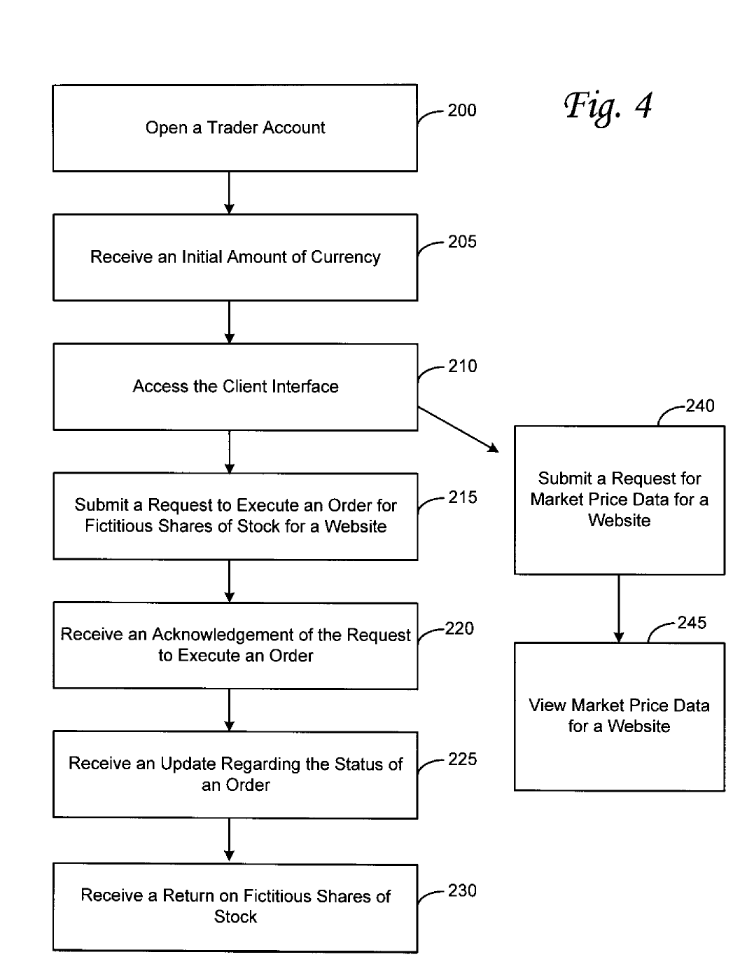

In the website exchange, traders, make their buying and selling decisions based on historical, current and predictive market data related to the success of the website, on both the website exchange and in reality. The market data is gathered from the website exchange and the online trade of the fictitious shares of stock of a plurality of websites and may further comprise external data related to factors that may include without limitation popularity, fad, earning capability, website-related events and business-related events. The website exchange simulates an actual stock exchange wherein the incentive to buy a fictitious share of stock is the expectation of a future return, which the trader may attempt to predict by analyzing market data. For example, it is profitable for the trader to own a fictitious share at a current market price that is below a predicted market price, and the expectation is that the fictitious share does indeed reflect an expected future return based on the predicted market price of the fictitious share with regard to the website. As further described herein with respect to FIG. 4, the future return may also be in the form of a dividend that is paid to the traders holding the fictitious shares of a specific website for which a dividend may be payable. Thus, the market data may correlate to an accurate prediction of the future success of the website.

Specifically, a rank for a plurality of websites listed on the website exchange is calculated based on market data generated in connection with the website exchange. Market data may include the external data related to factors that correlate to the website, as described above. Market data may further include, but is not limited to, historical market data, such as initial market price per fictitious share, previous traffic data and previous rank; current market data, such as current market price per fictitious share, current traffic data and current rank and predictive market data, such as future market price per fictitious share, future traffic data and future rank. A value may be calculated to determine rankings for each of the websites listed on the website exchange. Alternatively, rankings may be determined for a given number of websites in a group, such as those websites that are categorized according to a particular industry, or whether the website is commercial versus noncommercial. The value of a website provides an indication as to the popularity, branding and general overall value of the website, as it is perceived by potential purchasers in the marketplace.

In its simplest form, the value of a website may be calculated by multiplying the current market price of a fictitious share of stock for a website by the number of outstanding shares of stock for the website. Thus, the current market price is based upon the buying and selling activities of the traders that consider market data when making decisions in trading. The market data may be used to further calculate predictive market data, such as a future website rank, future traffic data and future market price. Website-related data generated in connection with the website exchange, including but not limited to the market data, may be provided to advertisers and other market analysts and serve as the basis for a website evaluation tool for determining website and internet trends. Website-related data may further include demographic information that may be obtained from the traders.

The parties of the system described herein include a number of traders 5 that are engaged in the online trade of fictitious shares of stock for a plurality of websites; a host 10 that calculates and stores market data related to the exchange of the fictitious shares of stock and generates website-related data based on the market data, and at least one advertiser 15 that requests website-related data from the host 10 for the further assessment and analysis of advertising and marketing trends for one or more of a given number of websites. The parties of the system may also include other third party data providers 25, such as a webmaster or other website representative that provides additional website-related data to the host 10, including but not limited to traffic data; website revenue whether related to the sale of goods and services or from advertising in connection with the website; website-related events and corporate events, such as the release of a new product or a corporate merger. A third party data provider 25 may also include a traffic data generator that gathers website traffic data, such as through the use of a downloaded toolbar or by other forms of input from Internet users.

More specifically, with regard to the parties, a host 10 may be any individual or entity that creates a website exchange and facilitates the online trade of fictitious shares of stock for a plurality of websites. The host 10 calculates and stores the current market prices of the fictitious shares associated with the trading activities of the website exchange and may further generate predictive market prices for the plurality of websites based on the historical and current market prices of the shares. The host may further generate website-related data based on the market data and provide such website-related data upon request to advertisers 15 as a website evaluation tool.

A trader 5 may be anyone that is desirous of buying and selling fictitious shares of stock for a plurality of websites in connection with the website exchange of the system and method described herein, The online trade of fictitious shares of stock for the plurality of websites is preferably conducted over a global communications network, such as the Internet. Accordingly, a trader 5 may be located anywhere in the world. The website exchange is typically a form of entertainment with respect to the traders. Therefore, no special qualifications or skills are required to participate as a trader 5 in the website exchange.

An advertiser 15 is an individual or entity that is desirous of obtaining website-related related data for the assessment of a website. An advertiser 15 may be a business that is offering its own goods and services for sale, or the advertiser 15 may also be a marketing firm that has a number of individuals and businesses as clients and seeks to promote the goods and services of such individuals and businesses. The website-related data generated by the host 10 may be useful to an advertiser 15 that is considering the purchase of advertising space for the paid promotion of goods and services. However, as previously discussed, advertiser is utilized herein broadly to include any individual or entity that is interested in the website-related data generated by the host for purposes that may or may not be related to marketing. As similarly described with respect to the trader 5, the advertiser 15 may be located anywhere in the world.

A third party data provider 25 may be any third party that provides data to the host 10 that may be useful in the generation of website-related data. A third party data provider 25 may provide the host 10 with data related to any number of factors including but not limited to traffic for a particular website, website revenue, website-related events or events associated with the entity or individual that owns or operates the website. Data provided by a third party data provider 25 may be incorporated into market data calculations performed by the host 10, such as when ascertaining a rank for a particular website. In addition, the data provided by the third party data provider 25 may also be presented to the advertiser 15 as a separate category of website-related data in addition to the website-related data that is generated by the host 10.

An example of a third party data provider 25 is a traffic data generator, such as Alexa. As previously described, Alexa is primarily a search engine that also ranks websites according to traffic data collected through the use of a proprietary toolbar downloaded by its users. When Alexa users download the toolbar and use the same when navigating in the normal course of utilization of the Internet, Alexa collects the details of the user's browsing history. Alexa utilizes the collected data for the further calculation of a website rank for the websites visited by its users. The rank of a website is generally based on several months of historical traffic data gathered from the Alexa toolbar users and is calculated using an algorithm that utilizes a combined measurement of page views and unique users. Another third party data provider 25 is Google which utilizes a PageRank system to assess websites. In short, this system is essentially a vote by all of the other webpages on the Internet about the importance of a particular web page. A link to a webpage counts as a vote of support, but in contrast, if there is no link to the page, there is no support. However, the lack of a link to a webpage is viewed as an abstention from voting rather than a vote against a page.

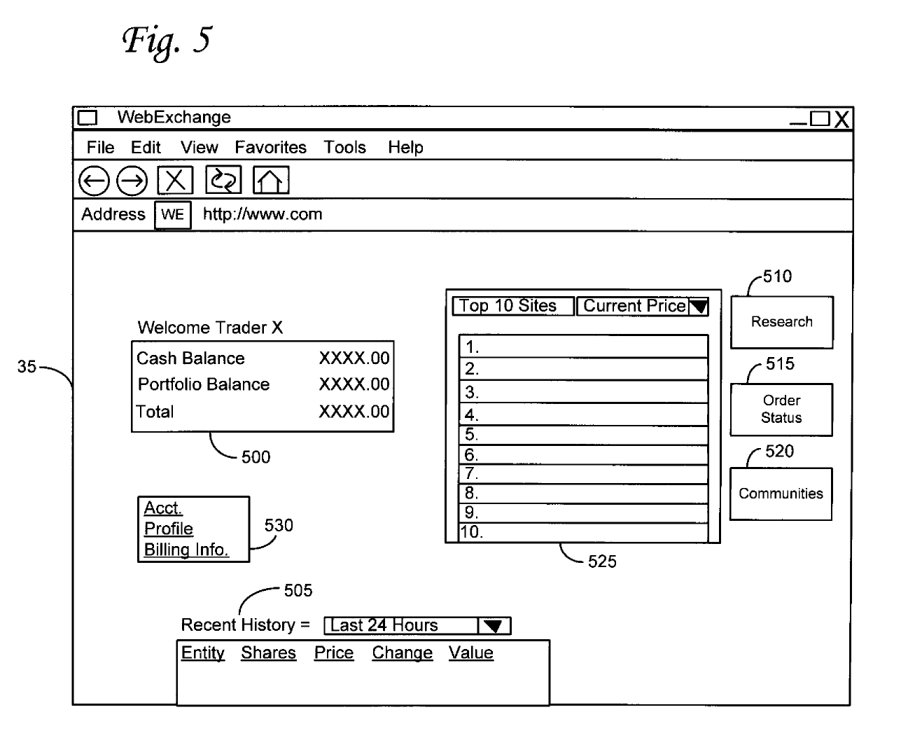

Similarly, a website that is listed on the website exchange may also be a source of third party data. A website that is listed on the website exchange, and about which little information is known, may benefit from providing data to the host 10. A representative for a website, such as a webmaster, may provide the host with data, such as traffic data, which may be obtained from sources such as a toolbar or a page counter that is placed on at least one webpage of a website. Similarly, data such as website revenue, or even business or website-related events, such as website modifications or updates or a merger or acquisition of the business operating the website or the release of a new product or service, may also be provided. The host 10 may make this information available to the traders 5, such as in connection with a research function that may be displayed on a client interface, as further described with respect to FIG. 5, to encourage the purchase of the fictitious shares of stock associated with the website. The host 10 may also provide advertising space, viewable on a client interface, which features a website to increase trader awareness and pique trader interest in potentially purchasing fictitious shares of stock for the website.

Additionally, the host may elect to provide a website analytic service for a particular website. In this regard, the host may gather statistical traffic data as it relates to a particular website and its visitor activity including without limitation, c-commerce information, page view history, unique history, visitor origin, visitor IP address and visit duration. The host may provide software to a webmaster for the purpose of gathering such data. The webmaster may voluntarily provide the statistical traffic data to the host gathered by the software or the statistical traffic data may be automatically transmitted to the host over the Internet.

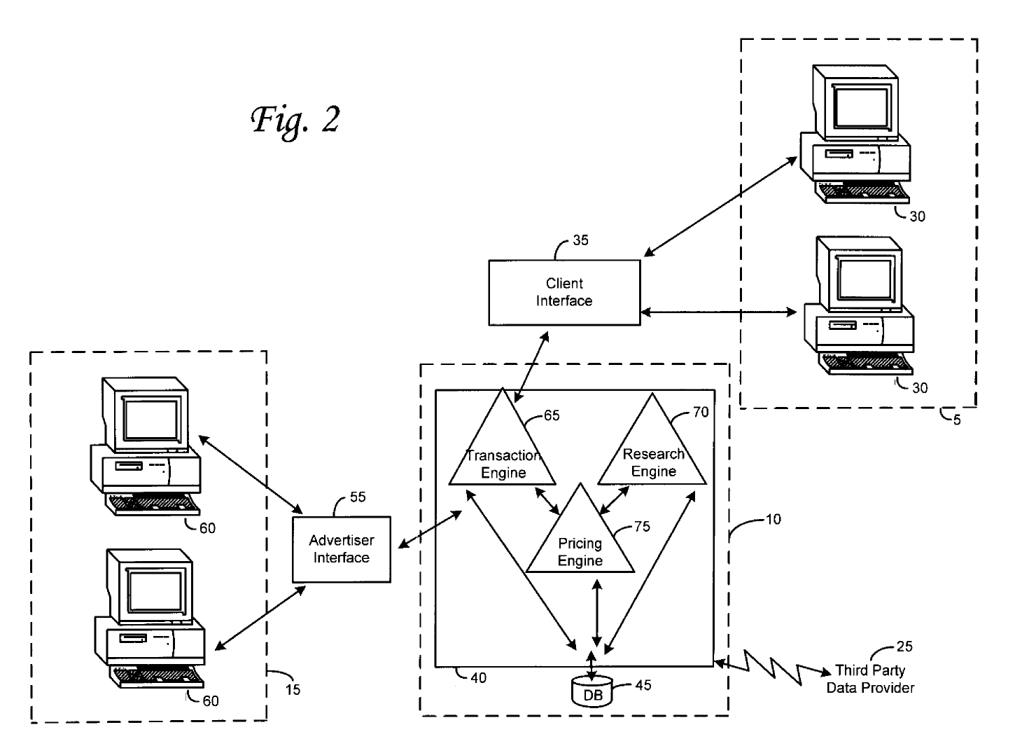

FIG. 2 is a schematic diagram of an exemplary system 1 for generating website-related data according to one aspect of the present invention. It should be appreciated by one skilled in the art that the illustrative embodiment shown in FIG. 2 is one suitable computing environment for the present invention and the method described herein may be implemented in any computing environment. As previously described, the online trade of fictitious shares of stock for a plurality of websites and the providing of website-related data to the advertiser 15 is preferably conducted over a global communications network, such as the Internet. However, the computing environment of FIG. 2, or portions thereof, may be configured on an intranet, thereby limiting the users of the system 1 to practice of the method described herein on a closed system.

Any number of traders 5 may access the system using a client device 30, and FIG. 2 illustrates a number of client devices 30 that are connected through the Internet to a host server 40. The client device 30 may be any type of device that can access, transmit and receive data over a global communications network. For example, the client device 30 may be a personal computer or the client device 30 may be personal digital assistant such as the Palm VII sold by Palm, Inc., or the Blackberry device sold by Research in Motion, Inc. The client device 30 should further include an input device, which may include a mouse or a keyboard or keypad, to facilitate the input of data or allow the selection of commands directing the host to execute orders in relation to the fictitious shares of stock.

The interaction between a host 10 and a trader 5 is conducted via the Internet through a client interface 35. The client interface 35 is the portal of communication between the client device 30 and the host server 40. The client interface 35 is basically a webpage that is capable of display in any standard Internet browser. An exemplary client interface 35 is shown and more fully described with respect to FIG. 5. The client interface 35 simulates a trading terminal and may depict the current portfolio of the trader and the recent trading activity of the trader. The client interface 35 may also provide the trader 5 with the ability to request market data for a given one or more of the plurality of websites. The trader 5 may also access account information or message boards, chat rooms or blogs from the client interface 35.

The host server 40, which may also be a personal computer, is configured to execute computer programs for carrying out the methods of the online trade of fictitious shares of stock for the plurality of websites. The host server 40 may comprise a transaction engine 65 which is responsible for receiving transaction requests from a client device 30 and communicating the requests, as necessary, for execution by the host server 40. The transaction engine 65 is responsible for return communication with a client device 30 with regard to status or execution of a transaction. Transaction requests may include requests to execute orders, account related requests and inquiries for market data for a particular one or more websites listed on the website exchange. The transaction engine 65 is also responsible for receiving transaction requests from an advertiser device 60 and communicating the requests, as necessary, for execution by the host server 40. Transaction requests received from an advertiser may include account inquiries and requests for website-related data. The transaction engine 65 is preferably available twenty-four hours a day and seven days a week. However, the host may choose to limit all trading activities to certain hours of the day or designated days of the week.

The host server 40 further comprises a pricing engine 75 which is configured to adjust a market price of the fictitious shares of stock to reflect a current market price based on requests to execute orders received from the client devices 30. The pricing engine 75 may automatically calculate the current market price of the shares for one of a given number of websites each time condition occurs, such as the receipt by the host server 40 of a request to execute an order for the fictitious shares of a website. Alternatively, the pricing engine 75 may update the current market price on a periodic basis, such as hourly, daily, weekly or monthly, based on transaction requests for the shares of stock for a website. The host 10 may manually direct the pricing engine 75 to update the current market price of the shares. Market data is stored in a database 45, as further described herein, each time the market price is adjusted. The market data stored in the database 45 may be accessed upon future inquiries received from a client device 30 for market data or an advertiser device 60 for website-related data.

The host server 40 may further comprise a research engine 70 which receives requests from the transaction engine 65 that originate from a client device 30 for market data. The trader 5 may request market data when deciding whether to place a request to execute an order for shares of fictitious stock for one of the websites listed on the website exchange. The research engine 70 also receives requests from the transaction engine 65 that originate from an advertiser device 60 for website-related data.

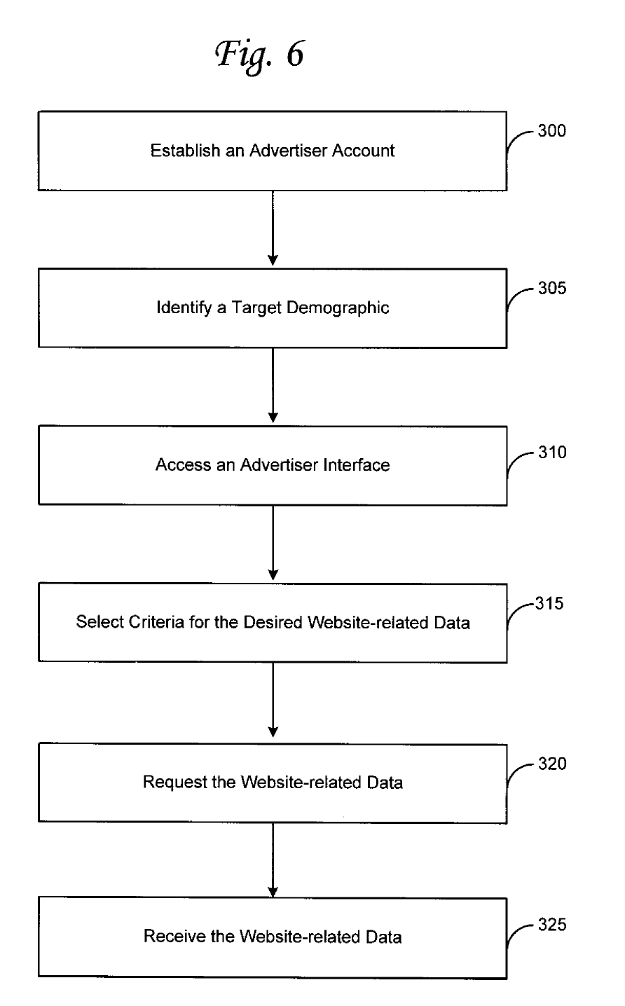

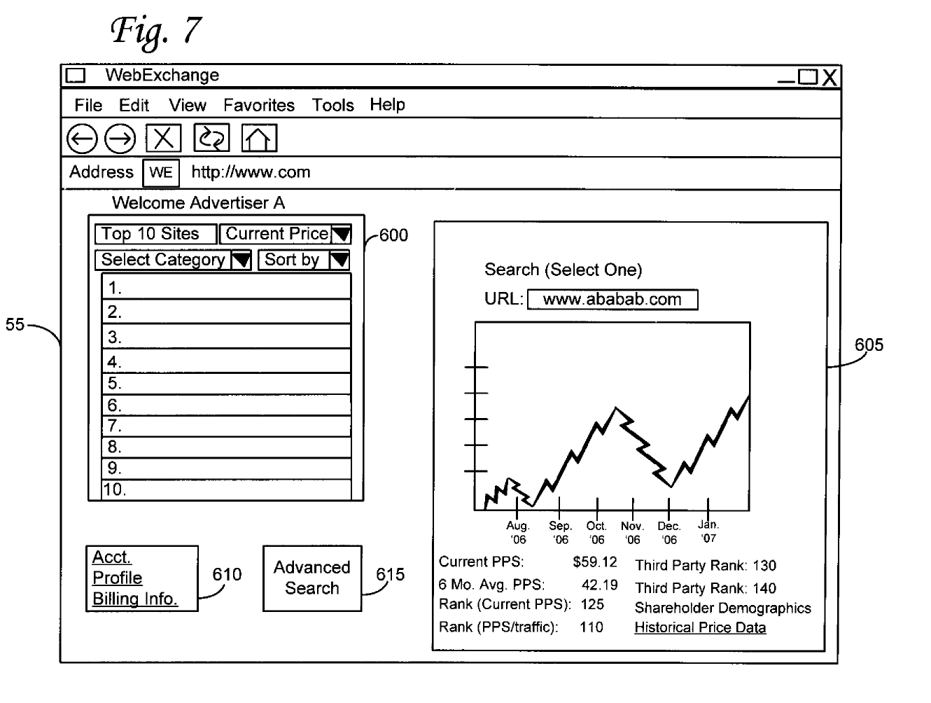

The host server 40 comprises a database 45 which stores all data that is kept by the system, which includes but is not limited to market data, third party data, trader account data as further described with respect to FIG. 4 and 5 and advertiser account data as further described with respect to FIGS. 6 and 7. The database is preferably a standard SQL database and is in communication with the transaction engine 65, the research engine 70 and the pricing engine 75 and provides access to data in response to requests received from a client device 30 and an advertising device 60.

An advertiser device 60 may be any type of device that can access, transmit and receive data over a global communications network. The interaction between the host 10 and an advertiser 15 is conducted through an advertiser interface 55. The advertiser interface 55 is the portal of communication between the advertiser device 60 and the host server 40. The advertiser interface 55 is basically a webpage that is capable of display in any standard Internet browser. An exemplary advertiser interface 55 is shown and more fully described with respect to FIG. 7. The advertiser interface 55 provides a front-end for an advertiser 15 who is desirous of accessing the system of the present invention to view and download statistical research data that has been compiled and stored in the database 45 with regard to trading history and demographic information of the traders 5.

Each of the client devices 30, the advertiser devices 60 and the host server 40 may be formatted with an operating system, such as Windows, Macintosh, UNIX and Linux. Other alternative hardware embodiments may be used without departing from the scope of the present invention.

The third party provider 25 may provide data to the host in any number of available methods. For example, the third party data may be provided to the host 10 in electronic format or the third party data may be provided to the host 10 as an image or on plain paper stock for conversion into an electronic format and possible storage in the database 45. Similarly, the host 10 may receive data from a website representative, such as a webmaster or website owner, in any of these formats.

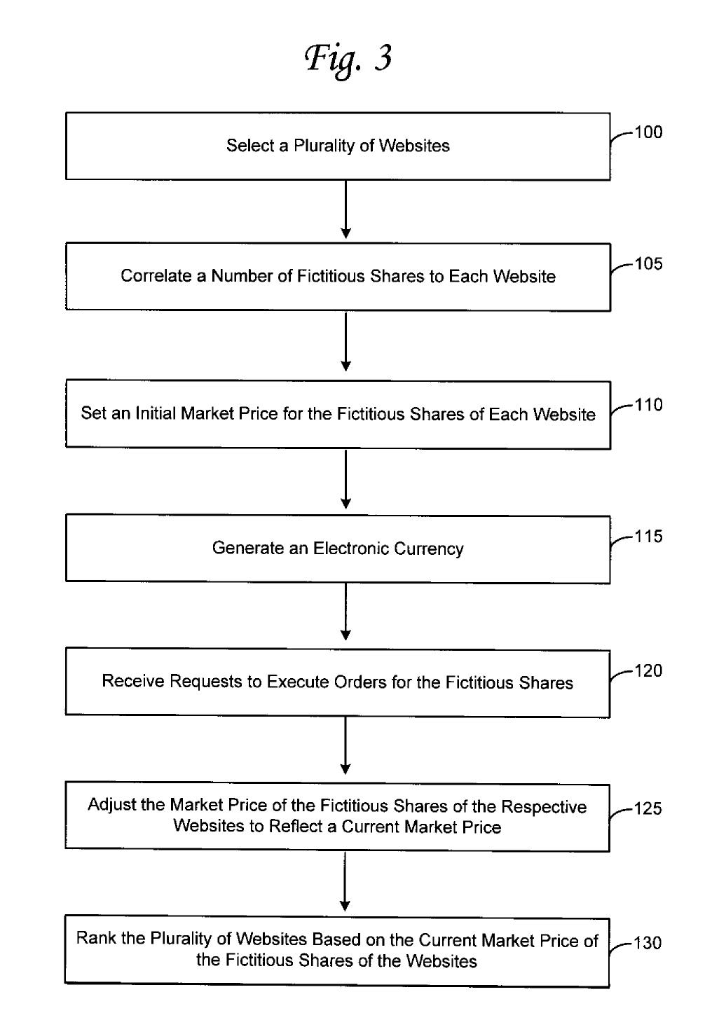

FIG. 3 illustrates the methodology of creating a website exchange and facilitating the online trade of fictitious shares of stock for a plurality of websites from the perspective of the host. The host must first create the website exchange, which is implemented in the form of a simulation of a stock exchange. At step 100 the host initially selects a plurality of websites for listing on the website exchange. The fundamental unit of trade on the website exchange is the fictitious share of stock in a website. At step 105, the host correlates an initial number of fictitious shares of stock to each website. Millions of websites currently exist today that can be listed on the website exchange. However, the host may arbitrarily select any random number of websites or, alternatively, the host may select websites to list on the website exchange based on certain criteria. The initial number of shares correlated to each website may be any arbitrary number of shares, as determined by the host. Alternatively, the number of shares that are correlated to each website may depend on external factors. For example, a certain website may be accorded a greater or lesser number of fictitious shares than another website as a result of external factors that may include traffic data, website revenue and website content. A website known to have a high amount of traffic may be accorded a greater number of fictitious shares of stock, whereas a lesser known website, or newly created website, may be accorded a lesser number of fictitious shares of stock, or vice versa.

In another embodiment, websites may be categorically classified into distinct divisions based on content, size or other criteria such as whether the website is commercial versus noncommercial. Each website contained within a particular category or division of websites may receive the same number of fictitious shares. Still yet in another embodiment, the website may receive a greater or lesser number of initial fictitious shares of stock based on data related to the business that is associated with the website. Business related data may include both financial factors, such as revenue, and non-financial factors, such as the size of the company or geographic location. Many sources exist from which business-related data can be obtained. For example, the Dun & Bradstreet Corporation, of Short Hills, N.J. provides access to a global commercial database that contains data regarding the financial position of a large number of businesses. Similarly, the financial webpage of various search engines provide a lookup feature wherein a user can obtain the latest financial data and news releases regarding a business, although this information is often limited to publicly traded companies. Also, the business associated with the website may provide the data.

Once the host decides to include a website in the website exchange and correlates a number of fictitious shares of stock to the website, the host should assign a ticker symbol to each website listed on the website exchange. The ticker symbol is generally a shorthand way by which a website can be identified in the website exchange. The ticker symbol should comprise a string of letters, although numbers may also be utilized in the string. Each ticker symbol is unique and should correspond to one website and its fictitious shares of stock. Accordingly, no two websites should have the same ticker symbol.

It is well known that a website is a collection of webpages that a user can access through a series of hyperlinks that are located on each webpage. Accordingly, a host may choose to associate fictitious shares of stock with a subsidiary webpage of a website. As such, the subsidiary webpages of the website to which fictitious shares of stock have been correlated may further have a unique ticker symbol. For example, a search engine website, such as www.yahoo.com, may have a number of linked webpages with each linked webpage corresponding to different subject matter. Linked webpages may include a financial webpage, a news webpage and an entertainment webpage. For purposes of the website exchange, the Yahoo! website may have a ticker symbol of YHOO. The subsidiary webpages of www.yahoo.com to which fictitious shares of stock have been correlated should each have a unique ticker symbol, although the ticker symbol may share the main ticker symbol as a root of its ticker symbol. The ticker symbol for the Yahoo! financial webpage may be YHOOFIN.

The correlation of fictitious shares of stock to the subsidiary webpages of a website is not only beneficial to the traders but also to the advertisers for several reasons. First, some webpages of a website may receive more traffic or enjoy more popularity than other webpages of the website. A trader may purchase the stock associated with a subsidiary webpage because it is the only webpage of the website in which he has interest. Next, the correlation of fictitious shares of a website to the subsidiary webpages of a website and trading of the same allows the host to generate additional website-related data that is more specific and detailed. The website-related data may indicate that a particular webpage of a website is popular with only a certain demographic of the traders which may also correspond to the demographic of the visitors to the website. Moreover, the different webpages of a website can each present a distinct advertising opportunity. Specifically, an advertiser of a certain product may find that an advertisement would be more appropriate on one webpage than another because the advertiser's research indicates that a target demographic is more likely to view a subsidiary webpage. It may be ultimately useful for an advertiser to have access to website-related data as it pertains to the subsidiary webpages of the websites because the demographics of its shareholders may likely be representative of the website visitors.

Next at step 110, the host must establish an initial market price for the fictitious shares of stock Similar to the process of correlating a predetermined number of fictitious shares of stock for each website, the initial market price may be arbitrarily determined by the host. For example, the initial market price of the fictitious shares for a website may or may not be equal as between websites. Thus, the initial market price for each website may be set at one dollar, or the initial market price may be set at one hundred dollars. The step of assigning an initial market price may be more deliberative in that the initial market price may be determined by considering website-related data or business-related data. The initial market price per share for a particular website may be greater for an established website that generates a large amount of known revenue, and it may be less for a relatively new non-commercial website. Moreover, the initial market price for a subsidiary webpage of a website to which shares have stock have been correlated may not be equal to the initial market price for the other subsidiary webpages or the main webpage. Accordingly, the initial market price for the fictitious shares of a subsidiary webpage of a website may also be greater than the initial market price for the shares associated with the main page of the website.

Next at step 115, the host must generate an electronic currency with which a trader may purchase fictitious shares of stock. The host may establish a virtual bank which is the source of the funds that are credited to a trader for use in the purchase of the fictitious shares of stock. Traders may also borrow additional electronic currency from the virtual bank. The host may establish a system that has a predetermined amount of currency for distribution to traders, although a system having a predetermined amount of electronic currency may limit the number of traders in a particular game. Alternatively, the amount of electronic currency available for trading may be unlimited. It is contemplated that a simulation that involves traders in various countries may further utilize multiple currencies. Accordingly, the host may establish a single unit of electronic currency, or the host may configure the website exchange to accommodate multiple currencies that correspond to a currency exchange rate, which may be further based on external rate sources. The host may require a user to register for a trader account to receive an initial amount of electronic currency. A trader account is analogous to a traditional stock brokerage account, wherein the trader manages trading activities and other account transactions from the trader account. The trader account may also be required to conduct trading activities. The trader account is further described with respect to FIGS. 4 and 5.

At step 120, the host receives requests to execute orders for fictitious shares of stock. The requests to execute orders are received by the host server 40 from the client device 30 and are processed by the transaction engine 65. The requests to execute orders are similar to the actions taken by traders with respect to an actual stock exchange. Generally, each of the fictitious shares may have a trading bid and ask price on the website exchange in analogy to an actual stock exchange. There may be a bid stack and an ask stack, wherein the bid price is the highest offer on the bid stack and the ask price is the lowest offer on the ask stack. The following are common order types that may be requested by a trader. A market order is an order that requires immediate execution at the best price available. A limit order is an order to transact at a specified price, which guarantees the price at which the trader will buy or sell the security. A stop order is a stipulation on a limit order either to buy or sell a security only if the host can fill the entire order. A day order is an order that expires at the end of the business day if it has not been filled. A good until canceled order is an order either to buy or to sell a stock that remains in effect until the trader cancels it or until it is executed by the host. A fill or kill order is an order for immediate execution, such that if it cannot be immediately filled the order is automatically canceled. A short sell is the borrowing and selling of a stock with the hopes of returning the stock at a lower price. The host executes the orders received from the traders, if possible. The host may also permit the traders to trade on margin, which is the borrowing of electronic currency from the host to purchase the fictitious shares of stock. Such a practice allows a trader to increase his buying power because he can purchase more fictitious shares with less cash outlay which can result in a greater potential return. Essentially the traders uses his own electronic currency to pay for party of the purchase and borrows the rest of the purchase price from the host.

At step 125, the host adjusts the market price of the websites to reflect a current market price. As previously described, the market price for the fictitious shares of a website may be adjusted by the pricing engine upon the occurrence of an event, such as each time a request to execute an order for the fictitious shares of stock of a particular website is completed. Alternatively, the market price for the shares of a website may be adjusted on a periodic basis or manually by the host. It is preferable that the current market price of the fictitious shares may be adjusted in connection with the activities of the website exchange, as prices should fluctuate based on supply and demand.

At step 130, the host ranks a plurality of websites, wherein the rank corresponds to the value of a website. In one embodiment, the value of a website may be determined by multiplying the current market price of the fictitious shares for a website by the number of outstanding shares of stock. The plurality of websites are ranked in order of value of the websites with the highest ranked website corresponding to the highest value and the lowest ranked website corresponding to the lowest value. In another embodiment, the rank of the website may be determined by considering external factors in the calculation of the value of the website. The rankings of the websites may be available to traders in a variety of formats, including sortable lists, and can be viewed on the client interface, as further described with respect to FIGS. 4 and 5. The ranking of the websites may also be available to advertisers in a variety of formats, including sortable lists, and can be viewed on the advertiser interface, as further described with respect to FIGS. 6 and 7.

FIG. 4 represents the methodology of the website exchange from the perspective of the trader. At step 200, the trader may open a trading account to participate in the website exchange. Although the trading account may not be required to participate in the website exchange, the trading account may be necessary to track a trading history of the trader. As previously described, the trader account may also be required if the trader wishes to access certain portions of the website exchange that may otherwise not be available. For example, the trader may be required to register for a trader account to access a research function to view market data for a website. The trader may register for the system by providing contact information, including a name, an address and an email address. The trader may further be asked to provide demographic information that can include age, gender, occupation, income, interests and other hobbies. The trader may also be asked to provide information related to Internet utilization which may include but is not limited to, a list of his or her top favorite websites, the location where the trader primarily accesses the Internet, the location where the trader primary accesses the trading system and the times of day that the trader accesses the Internet. The trader may be randomly assigned a username and a password combination or the trader may select either one or both of the username and password. A user fee may be required to register for a trader account.

At step 205, the trader may receive an initial amount of electronic currency. This amount may be deposited in the trader account. As described, the trader utilizes the electronic currency to purchase the fictitious shares of stock. At step 210, the trader accesses the client interface which represents the trading display. An exemplary client interface is described with respect to FIG. 5. From the client interface, the trader may either submit a request to execute an order related to the fictitious shares of stock at step 215 or the trader may submit a request for market data for at least one of a given number of websites at step 240. At step 215, the trader submits a request to execute an order for at least one fictitious share of stock of a website. Examples of orders that may be submitted are described with respect to FIG. 3. At step 220, the trader receives an acknowledgment that the request to execute an order has been received by the host. At step 225, the trader may receive a periodic update regarding the status of the execution of the orders. The trader may be required to refresh the client interface to view the updated status of the orders, and the trader may view the status of such orders on the client interface. In addition, the trader may receive an update on the status of an order via email.

At step 230, the trader may receive a return on some of the fictitious shares of stock that he holds in his portfolio. The incentive to purchase the shares of fictitious shares of stock is the likelihood of a positive future return which may increase the amount of electronic currency held by the trader in his trader account. The return received by a trader may also be negative which may cause the trader to trade the fictitious shares of stock. A return may be the difference between the market price at which the trader purchased the fictitious share of stock and the market price at which the trader sold the fictitious share of stock. A fictitious share of stock may also earn a return in the form of a dividend that corresponds to that fraction of the total return divided by the number of outstanding shares. The total return may be calculated based on a formula that also accounts for selected external factors over a period of time, which may include without limitation, an estimated fraction of click-throughs per hit of traffic to a website, overall traffic to a website, third party data regarding a website, a third party ranking for a website, revenue generation related to either the website or the business entity associated with the website, corporate events and website-related events. The total return may be a weighted average of the market data for a website and any such external factors. The total return factors may vary from website to website and may depend on access to varying levels of reliable or accurate information.

Instead of or in addition to a fictitious return in the traders trading account, a trader may earn a real reward from the host by demonstrating a superior trading performance or attaining a superior level of trading performance. For example, the trader may receive a prize, such as cash or an item of value. The trader may also receive a title that is indicative of the superior trading performance of the trader. The trader may also receive additional virtual currency that may be deposited into the trader account.

When the trader accesses the client interface at step 210, the trader may want to view the market data for the fictitious shares of one of a given number of websites. A trader generally decides to buy or sell a particular share of stock based on current and historical market prices. Accordingly, at step 240, the trader may submit a request for market data for the particular stock. At step 245, the trader may view the market data and determine whether the current market price is too high or too low based on trends in the market data presented to the trader.

FIG. 5 is an exemplary embodiment of a client interface 35 according to one aspect of the invention. The client interface 35 is a webpage that simulates a trading terminal and is the portal through which all interaction with the host is conducted. The client interface 35 may include a portfolio snapshot 500 which represents the current status of the trader. The portfolio snapshot 500 may include the amount of available electronic currency available for trading, the amount held in the fictitious shares of stock and the total value of the portfolio of the trader. A recent history 505 allows the user to view market activity with regard to each of the websites for which the user holds fictitious shares of stock. The recent history 505 may include, but is not limited to, the ticker symbol of the fictitious shares of stock for a website, the number of fictitious shares of stock held by the trader, the current market price, the current rank and the current value of the website, if different than the current rank. The recent history 505 may also give the trader the option to view the change in market price over a time period selected by the trader. The client interface 35 may further include a top websites list 525 which is a sortable list of a number of ranked websites and the current market price of the correlated fictitious shares of stock. The client interface 35 may also include a research area 510 for researching the market data of the fictitious shares of stock for the websites. The client interface 35 may include a communities area 520 for communicating with other traders. The communities area 520 may include message boards where traders can post messages to which the other traders can respond in addition to chat rooms and blogs on which traders can discuss the website exchange and provide tips to each other. The client interface 35 may include an account area 530 where the trader may access information such as the trader's demographic profile, billing information or other account information. The client interface 35 may also include an order status area 515 where the trader may view the current status of any requests to execute orders.

FIG. 6 represents the methodology of the request and receipt of website-related data from the perspective of the advertiser. The advertiser may be desirous of viewing the website-related data that may be generated by the host with respect to the websites listed on the website exchange. At step 300, an advertiser may be required to establish an account with the host for the request and receipt of website-related data. The advertiser may establish an account by signing up on the website of the host or alternatively the advertiser may establish an account by telephone or by postal mail. The advertiser may select a username and a password for access to the advertiser account. Similar to the trading account, the advertiser may select a unique username and/or password combination. Alternatively, the username and password may be randomly generated.

At step 305, the advertiser may identify the target demographic for goods and services that it wishes to promote. It should be noted that the advertiser need not identify a target demographic prior to requesting website-related data nor does the advertiser need to identify a target demographic at all. However, it may be useful for an advertiser to request website-related data with an eye toward the ultimate targeted customers for a good or service. For example, the host may charge a fee for each search that is conducted by an advertiser. In a fee-based system, the advertiser may want to narrow its search criteria before requesting website-related data.

At step 310, the advertiser accesses the advertiser interface, such as shown in FIG. 7. As previously stated, the advertiser interface is the portal through which online requests for website-related data are made. The advertiser accesses the advertiser interface by providing the established user name and password. The advertiser interface presents a variety of search options which the advertiser may use to view website-related data for selected websites. At step 315, the advertiser may select the criteria for the website-related data it wants to obtain. For example, the advertiser may want to access website-related data for the top ten websites that are ranked according to their value. Similarly, the advertiser may wish to access website-related data for the top ten websites for which the majority of shares are held by traders between the ages of 29 and 34. Further an advertiser may want to access website-related data for the top twenty websites for which the majority of shares are held by traders having a certain income level.

At step 320, the advertiser submits a request for the website-related data based on the selected criteria. The request for data is transmitted to the host server via the internet and received by the transaction engine. The transaction engine directs the request to the research engine which further queries the database. At step 325, the advertiser receives the requested website-related data which is displayed on the advertiser interface. The advertiser may view the website-related data on the advertiser interface or the advertiser may also download or print the website-related data for further review.

FIG. 7 is an exemplary embodiment of an advertiser interface 55. The advertiser interface 55 may include an account area 610 where the advertiser can view or change account information including a profile, billing information and recent requests for website-related data. The advertiser may have the ability to view previously requested website-related data under the recent requests for a certain period of time after which the previously requested website-related data may be automatically deleted. The advertiser interface 55 may include a variety of search options for requesting website-related data. First, the advertiser interface 55 may include a single website search section 605. In this section, an advertiser may view graphic or chart-like presentations of the website-related data for a particular website over a period of time. Additionally, this section may include more detailed statistical information for the selected website such as current market price per share; a six month average market price per share; a current rank calculated on current market price per share; a current rank calculated on current market price per share in addition to other external factors, including but not limited to traffic; and third party rankings. Shareholder demographics for the website may be accessible in the single website search section 605. The advertiser interface 55 may also include a browsing section 600 where the advertiser may select a certain number of the top websites according to rank, which may be presented on a sortable list. The advertiser may follow a hyperlink for each website on the list to view the website-related data for a specific website. The advertiser may also have the ability to select a certain number of the top websites according to rank in relation to certain categories of websites. The advertiser interface 55 may further comprise an advanced search section 615 where the advertiser may select from any number of available detailed search criteria and request website-related data.

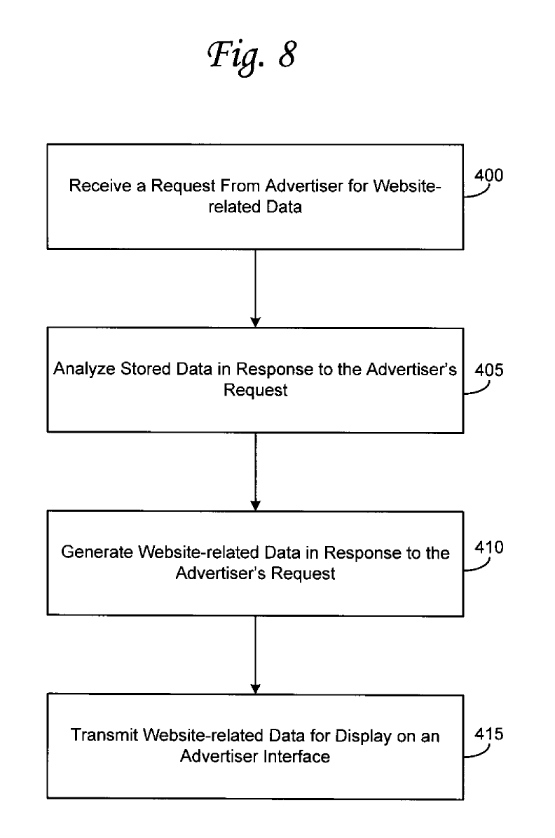

FIG. 8 represents the methodology of providing website-related data to an advertiser in response to a request for such data from the perspective of the host. At step 400, a host server receives a request from an advertiser for website-related data. The advertiser submits such a request through the advertiser interface and it is transmitted to the host server through the Internet. The request is received by the transaction engine of the host server, which recognizes the request as an advertiser request and communicates the request to the research engine. At step 405, the research engine analyzes the request and queries the database in response to the request. At step 410, the website-related data is returned in response to the advertiser's request for such data according to the selected criteria. The research engine communicates this data to the transaction engine which transmits the website-related data to the advertiser for display on the advertiser interface at step 415.

In addition to the website exchange providing a form of entertainment in which the players trade fictitious shares of stock for a plurality of websites, the website exchange provides a market prediction of the future success of the website, as it may relate to a future rank and market data, based on the current market price of the shares. Market data generated from the website exchange may be useful to advertisers and internet analysts. The website exchange may help advertisers and website owners to optimize advertisements and websites and further enhance the businesses that may be associated with the websites.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for generating data related to a plurality of websites by facilitating the exchange of fictitious shares of the plurality of websites, the method comprising the steps of:
correlating a predetermined number of fictitious shares to each website;
setting a market price for the fictitious shares of each website;
generating an electronic currency;
receiving requests to execute orders related to the fictitious shares of the websites in connection with the electronic currency;
adjusting the market price of the fictitious shares of the respective websites to reflect a current market price based on the requests to execute orders;
generating market data based on the market price of the fictitious shares of the respective websites and
ranking the plurality of websites based on the market data.

2. The method of claim 1, further comprising a step of obtaining traffic data for at least one of a given number of websites.

3. The method of claim 2, wherein the step of ranking the plurality of websites is based on the current market price and the traffic data for the websites.

4. The method of claim 2, wherein the traffic data associated with the website is utilized to set an initial market price of the fictitious shares of the website.

5. The method of claim 1, further comprising a step of storing market data for the fictitious shares of the respective websites.

6. The method of claim 5, wherein the market data includes at least one of an initial market price per fictitious share, a current market price per fictitious share, a previous market price per fictitious share, a current website rank and a previous website rank.

7. The method of claim 5, further comprising a step of deriving predictive market data for at least one of a given number of websites, wherein the predictive market data is derived from at least the market data for the websites.

8. The method of claim 7, wherein the predictive market data includes a future website rank.

9. The method of claim 7 wherein the predictive market data includes future traffic data.

10. The method of claim 7, wherein the predictive market data includes a future market price per fictitious share.

11. The method of claim 7, wherein the market data is provided to a third party.

12. The method of claim 1, wherein the step of correlating a predetermined number of fictitious shares is in relation to a subsidiary page for one of a given number of websites.

13. The method of claim 1, wherein the revenue of a business associated with the website is utilized to set an initial market price of the fictitious shares of the website.

14. The method of claim 1, further comprising a step of requiring a user to register for a trader account, wherein the receiving step includes receiving a request to execute an order from the user via the trader account.

15. The method of claim 14, further comprising a step of modifying the trader account in response to a request to execute an order received from a user.

16. The method of claim 14, wherein the user provides demographic data that is stored in association with the trader account.

17. The method of claim 15, further comprising a step of providing the demographic data and market data to a third party.

18. A system for generating website-related data in connection with an exchange of fictitious shares of a plurality of websites, the system comprising:
a host server configured to receive and transmit data related to the fictitious shares of the plurality of websites over a global communications network, the host server including:
a client interface configured to direct communications received over the global communications network between the host server and a client device;
a transaction engine configured to respond to orders associated with the exchange of the fictitious shares of the plurality of websites, the orders being received by the host server from the client device via the client interface;
a pricing engine configured to receive data from the transaction engine related to the orders, the data related to the orders being used to calculate a current market price of the shares for at least a given one of the plurality of websites; and
a research engine configured to respond to a request for data related to the orders and
a database configured to store the data related to the orders.
